(19) United States
(12) Patent Application Publication
(10) Pub. No.: US 2018/0349878 A1
(43) Pub. Date: Dec. 6, 2018

(54) EXPIRING BALANCE FOR SPENDING OR PASSING ALONG TO A FRIEND

(71) Applicant: PAYPAL, INC., San Jose, CA (US)

(72) Inventors: Ted Helwick, San Jose, CA (US); Stan Chudnovsky, Burlingame, CA (US); Faran Najafi, Newbury Park, CA (US); Clare Jones, San Francisco, CA (US)

(21) Appl. No.: 15/821,655

(22) Filed: Nov. 22, 2017

Related U.S. Application Data
(62) Division of application No. 14/160,456, filed on Jan. 21, 2014, now abandoned.
(60) Provisional application No. 61/877,834, filed on Sep. 13, 2013.

(51) Int. Cl. G06Q 20/22; G06Q 20/10

(52) U.S. Cl. CPC G06Q 20/223; G06Q 20/10

(57) ABSTRACT

An expiring balance may be provided to a user account that the user can spend or pass along to a friend. The user may be given a limited time in which to spend the expiring balance after which the balance will not be available to the user. When the user decides to pass the balance along to a friend, an expiration time associated with the expiring balance may be reset. The expiring balance may be redeemed at participating locations and, if a location is not participating, the user may be able to notify an entity providing the expiring balance of the non-participation.

### CROSS REFERENCE TO RELATED APPLICATIONS

This application is a divisional of U.S. patent application Ser. No. 14/160,456, filed Jan. 21, 2014, which claims the benefit of and priority to U.S. Provisional Patent Application No. 61/877,834, filed Sep. 13, 2013, both of which are hereby incorporated by reference in their entirety.

### BACKGROUND

### Technical Field

Embodiments disclosed herein are related to providing a user with an expiring balance that may either be spent or passed along to friend before the balance expires.

### Related Art

The increased use of the internet and internet capable devices has led to the increased use of online payment processors due to the convenience that these processors provide. Online payment processors may provide consumers with the ability to purchase items with minimal effort from their internet capable device, with the payments being handled through a consumer's credit or checking account, or through a financial account that the consumer has set up with the payment processor. Merchants may also be able to set up accounts with the payment processor so that users with accounts may pay the merchant using the payment processor, which may simplify transactions for both the merchant and the consumer. However, both merchants and consumers may need to sign up for accounts with the payment processor in order to take full advantage of the convenience offered by the payment processor.

Special offers, promotions, daily deals and the like, often have an expiration date after which they may no longer be taken advantage of. As a result, the limited time associated with these may create interest amongst consumers and cause the consumer to act so that they do not miss out on the deal. As a result, offering limited time special offers or promotions may generate interest in a business and may even temporarily increase the revenues received by the business while the promotion is being offered. Moreover, a consumer may be more likely to act on a promotion when the promotion has a limited time.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIGS. 3A and 3B are example interfaces for spending or passing along an expiring balance, consistent with some embodiments.

FIGS. 4A and 4B are example interfaces for identifying nearby merchants and notifying a server that an expiring balance is not accepted, consistent with some embodiments.

FIGS. 5A-5C are example interfaces and for selecting a friend to pass the expiring balance along to and receiving the expiring balance that was passed along, according to some embodiments.

FIG. 6 is a flowchart illustrating a process for providing an expiring balance to a user for spending or passing along to a friend, consistent with some embodiments.

FIG. 7 is a flowchart illustrating a process for spending or passing along an expiring balance, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

What is needed are expiring balances associated with a user account on a payment processor server for spending or passing along to a friend that may be used to generate interest in a business or to promote activity and accounts with an online payment processor.

Consistent with some embodiments, there is provided a system. The system includes one or more processors configured to add an expiring balance to an account associated with a user, determine when the balance has expired and subtract the expiring balance from the account when the balance has expired, determine when the user is requesting to process a payment using the expiring balance and process the payment and subtract the expiring balance from the account when the user requests to process a payment using the expiring balance, determine when the user is sending a notification including merchant information for a merchant that will not accept the expiring balance as a payment and store the merchant information when the user sends the notification, and determine when the user is requesting to pass the expiring balance on to a friend. The system further includes a memory coupled to the one or more processors and configured to store the account associated with the user and the merchant information.

Consistent with some embodiments, there is also provided a method including steps of adding an expiring balance to an account associated with a user; subtracting the expiring balance from the account when the balance has expired, processing the payment and subtracting the expiring balance from the account when the user requests to process a payment using the expiring balance, sending a notification including merchant information for a merchant that will not accept the expiring balance as a payment and storing the merchant information when the user sends the notification, and determining when the user is requesting to pass the expiring balance along to a friend. The method may be embodied in computer-readable media.

Consistent with some embodiments, there is further provided a method including steps of receiving a notification of a received expiring balance, sending friend information when the expiring balance is sent to a friend, displaying a list of nearby merchants, sending merchant information when a merchant does not accept the expiring balance, and sending payment information when spending the expiring balance. The method may be embodied in computer-readable media.

Embodiments disclosed herein may allow an online payment processor to add an expiring balance to a user's account which may be spent or passed along to another person before expiring. When attempting to use the balance at a merchant, the user may be able to identify merchants that do not accept payments processed by the payment processor and provide this information to the payment processor. Moreover, when attempting to pass the balance along to a friend, the user may be required to register for an account with the payment processor before being able to spend or pass the expiring balance. The expiring balance may provide incentives and motivation for additional users to register with the payment processor and for additional merchants to register with the payment processor to take advantage of the additional business that may be generated by users spending the expiring balance.

These and other embodiments will be described in further detail below with respect to the following figures.

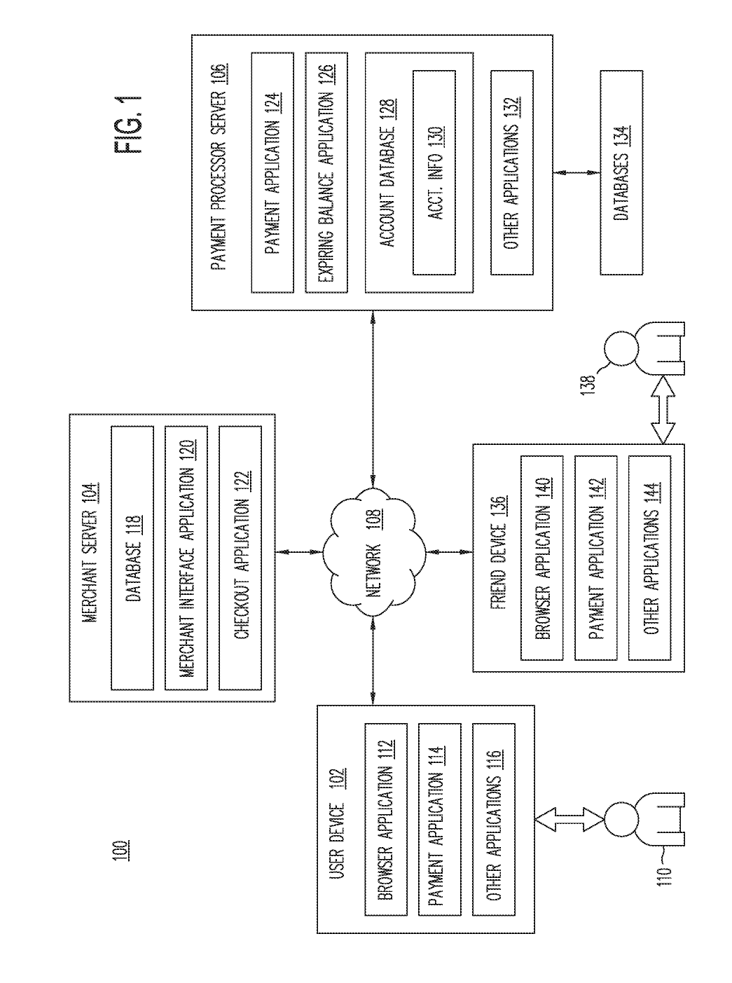

FIG. 1 is a block diagram of a networked system 100, consistent with some embodiments. System 100 includes a user device 102, a merchant server 104, and a payment processor server 106 in communication over a network 108. User 110 may be communicating with merchant server 104 and/or payment processor server 106 over network 108 using user device 102. Payment processor server 106 may be a payment service processor or provider server that may be maintained by a payment processor or provider, such as PayPal, Inc. of San Jose, Calif. Payment processor server 106 may be maintained by other service providers in different embodiments.

Network 108, in one embodiment, may be implemented as a single network or a combination of multiple networks. For example, in various embodiments, network 108 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

User device 102 may be a mobile device such as a smartphone, a tablet computer, a laptop or netbook, and the like. User device 102 may also be a personal computer, a set-top box (STB) such as provided by cable or satellite content providers, a video game system console, or a smart or internet-enabled television. User device 102 may also be a head-mounted display (HMD) or other wearable computing device. In some embodiments, user device 102 may be implemented in an automobile, for example in an entertainment center or console of an automobile, or is included or implemented in a healthcare device. User device 102 may be implemented using any appropriate combination of hardware and/or software configured for wired and/or wireless communication over network 108. Consistent with some embodiments, user device 102 may include any appropriate combination of hardware and/or software having one or more processors and capable of reading instructions stored on a non-transitory machine-readable medium for execution by the one or more processors. Consistent with some embodiments, user device 102 includes a machine-readable medium, such as a memory (not shown) that includes instructions for execution by one or more processors (not shown) for causing user device 102 to perform specific tasks. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read. Instructions stored on the machine-readable media may include instructions for authenticating user device 102 to payment processor server 106 to access services provided by payment processor server 106 and/or conducting financial transactions with payment processor server 106 for purchasing items offered by merchant server or device 104.

Such instructions may include instructions for displaying content by particular applications or “apps” stored in a memory of user device 102 and executed by one or more processors executing in user device 102. Example applications include a browser application 112 that displays content, such as a web page or a user interface using a browser, a payment application 114 that may be used to make payments in conjunction with payment processor server 106 for goods and/or services (referred to collectively as “items”). The items may be purchased from a merchant having a physical storefront or a digital storefront that is represented by merchant server 104. Browser application 112 may be implemented as a web browser to view information available over network 108. Browser application 112 may include instructions executable by one or more processors for interfacing and communicating with payment processor server 106, a merchant interface provided by merchant server 104, or other servers managed by content providers or merchants via network 108. For example, user 110 may be able to access websites using browser 112 to find and purchase items from merchant server 104 through a payment service provider provided by payment processor server 106, such as PayPal, as well as access user account information or web content. In some embodiments, user 110 may be able to use payment application 114 to pay for items, with the payments being processed by payment processor server 106.

In some embodiments, payment application 114 may be able to interact with payment processor server 106 to receive an expiring balance. In some embodiments, when payment processor server 106 adds an expiring balance to an account of user 110 a notification may be sent from payment processor server 106 to user device 102 which may cause payment application 114 to generate a push notification to be displayed by user device 102. Interacting with the push notification may activate payment application 114 where user 110 may be able to view the expiring balance as well as the time remaining to spend the balance. User 110 may further be provided with options for spending the balance or passing the balance along to a friend. User 110 may also use payment application 114 to view a listing of merchants that accept payments processed by payment processor server 106 such that the merchants will accept the balance added to their account. User 110 may also be able to use payment application 114 to notify payment processor server 106 of merchants who do not accept payments processed by payment processor server 106 and, thus, do not accept the added balance. User 110 may further use payment application 114 to spend the expiring balance. In some embodiments, spending the expiring balance may require one or more credentials, such as a user name or password, to be provided to payment processor server 106 for authentication to payment processor server 106.

Other applications 116 may be desired in one or more embodiments to provide additional features available to user 110, including accessing a user account with payment processor server 106. For example, other applications 116 may include interfaces and/or communication protocols that allow the user to receive and transmit information through network 108 and to payment processor server 106 and other online sites. Other applications 116 may also include security applications for implementing client-side security features, programmatic client applications for interfacing with appropriate application programming interfaces (APIs) over network 108 or various other types of generally known programs and/or applications. Other applications 116 may include mobile apps downloaded and resident on user device 102 that enable user 110 to access content through the apps.

Merchant server 104 may be maintained, for example, by a merchant or seller offering various items in exchange for payment to be received over network 108. In some embodiments, merchant server 104 may be in communication with a point of sale (POS) device maintained by the merchant in a physical storefront. Merchant server 104 may also include a database 118 identifying available items which may be made available for viewing and purchase by user 110. Database 118 may include descriptions, images, and pricing of the items. Merchant server 104 may also include a merchant interface application 120 which may be configured to serve information over network 108 to browser application 112 and/or payment application 114 of user device 102. In some embodiments, user 110 may interact with merchant interface application 120 through browser application 112 and/or payment application 114 over network 108 in order to view various products, food items, or services identified in database 118.

Merchant server 104 also includes a checkout application 122 which may be configured to facilitate the purchase by user 110 of goods or services identified by merchant interface application 120. Checkout application 122 may be configured to accept payment information from or on behalf of user 110 through payment processor server 106 over network 108. For example, checkout application 122 may receive and process a payment confirmation from payment processor server 106, as well as transmit transaction information to payment processor server 106 and receive information from payment processor server 106. Checkout application 122 may also be configured to accept one or more different funding sources for payment including payments processed by payment processor server 106.

Payment processor server 106, according to some embodiments, may be maintained by an online payment provider, such as PayPal, Inc. of San Jose, Calif., which may provide processing for online financial and information transactions on behalf of user 110. In some embodiments, payment processor server 106 may also be capable of adding an expiring balance to an account of user 110. Payment processor server 106 may include payment application 124, which may be adapted to interact with user device 102 and merchant server 104 to process payments to be made by payment processor server 106 for items purchased by user 110 using user device 102, including items purchased from merchant server 104. Such payments may include payments made when user 110 uses payment application 114 to check in at a merchant to order and pay for items or order items ahead. Payment processor server 106 may also include an expiring balance application 126. In some embodiments, expiring balance application 126 may be capable of adding an expiring balance to an account of user 110 that can be spent or passed along before the balance expires. Expiring balance application 126 may further be capable of handling the passing along of the expiring balance to another user as designated by user 110. An account of user 110 and designated users for passing along the expiring balance may be stored locally in account database 128.

Account database 128 may include one or more databases, each of which may include account information 130 associated with individual users. For example, account information 130 may include private financial information of users of payment processor server 106 such as account numbers, credentials, passwords, device identifiers, user names, phone numbers, credit card information, bank information, or other financial information which may be used to facilitate online transactions by users such as user 110. Payment processor server 106 may also include other applications 132 and one or more additional databases 134 that may store additional information for use by payment processor server 106.

In some embodiments, system 100 may also include a friend device 136 which may be used by a friend 138 or contact of user 110. Friend device 136 may be similar to user device 102, and may also include a browser application 140, payment application 142, and other applications 144, all of which may include similar functionality to their counterparts on user device 102. In general, user 110 may pass along an expiring balance to friend 138, by notifying payment processor server 106 that user 110 wants to pass along the expiring balance to friend 138 which may cause payment processor server 106 to remove an expiring balance from an account of user 110 and add an expiring balance to an account of friend 138. In some embodiments, the expiration time may be reset when the expiring balance is added to an account. If friend 138 does not have an account with payment processor server 106, friend 138 may be prompted to create an account with payment processor server 106. When payment processor server 106 adds the expiring balance to an account of friend 138, a notification may be sent from payment processor server 106 to friend device 136 which may cause payment application 142 to generate a push notification to be displayed by friend device 136. Interacting with the push notification may activate payment application 142 where friend 138 may be able to view the expiring balance as well as the time remaining to spend the balance. Friend 138 may further be provided with options for spending the balance or sharing the balance with another friend or even user 110. Friend 138 may also use payment application 142 to view a listing of merchants that accept payments processed by payment processor server 106 such that the merchants will accept the balance added to their account. Friend 138 may also be able to use payment application 142 to notify payment processor server 106 of merchants who do not accept payments processed by payment processor server 106 and, thus, do not accept the added balance.

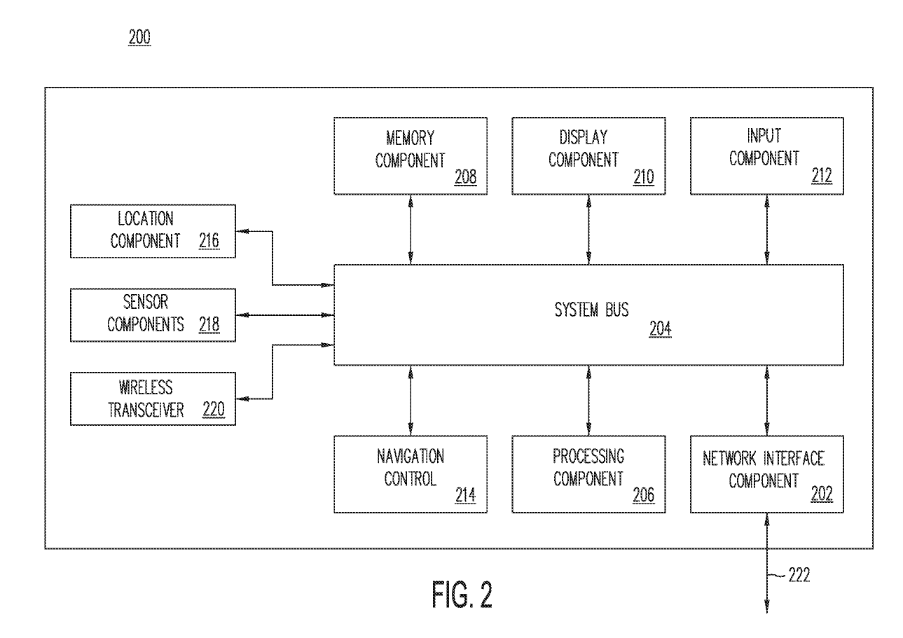

FIG. 2 is a diagram illustrating computing system 200, which may correspond to any of user device 102, merchant server 104, payment processor server 106, or friend device 136 consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as may be consistent with user device 102 or friend device 136. Further, computing system 200 may also be a server or one server amongst a plurality of servers, as would be consistent with merchant server 104 and payment processor server 106. As shown in FIG. 2, computing system 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 108.

Consistent with some embodiments, computing system 200 includes a system bus 204 for interconnecting various components within computing system 200 and communicating information between the various components. Such components include a processing component 206, which may be one or more processors, micro-controllers, graphics processing units (GPUs) or digital signal processors (DSPs), and a memory component 208, which may correspond to a random access memory (RAM), an internal memory component, a read-only memory (ROM), or an external or static optical, magnetic, or solid-state memory. Consistent with some embodiments, computing system 200 further includes a display component 210 for displaying information to a user 110 of computing system 200. Display component 210 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 212, allowing for a user of computing system 200, such as user 110 or friend 138, to input information to computing system 200. Such information could include payment information such as an amount required to complete a transaction, account information, authentication information such as a credential, or identification information. An input component 212 may include, for example, a keyboard or key pad, whether physical or virtual. Computing system 200 may further include a navigation control component 214, configured to allow a user to navigate along display component 210. Consistent with some embodiments, navigation control component 214 may be a mouse, a trackball, or other such device. Moreover, if system 200 includes a touch screen, display component 210, input component 212, and navigation control 214 may be a single integrated component, such as a capacitive sensor-based touch screen.

Computing system 200 may further include a location component 216 for determining a location of computing system 200. In some embodiments, location component 216 may correspond to a GPS transceiver that is in communication with one or more GPS satellites. In other embodiments, location component 216 may be configured to determine a location of computing system 200 by using an internet protocol (IP) address lookup, or by triangulating a position based on nearby telecommunications towers or wireless access points (WAPs). Location component 216 may be further configured to store a user-defined location in memory component 208 that can be transmitted to a third party for the purpose of identifying a location of computing system 200. In some embodiments, a location determined by location component 216 may be used to trigger payment processor server 206 to add an expiring balance into an account associated with user 110. For example, computing system 200 may send provide a location determined by location component 216 to payment processing server 106 and processing component 206 of payment processing server 106 may determine if the location is a location where an expiring balance may be used and add an expiring balance to an account associated with user 110 when the location is a participating location. Alternatively, the location may be determined by a geofence set up around the location that may trigger the addition of the expiring balance when user 110 enters the geofenced area. Computing system 200 may also include sensor components 218. Sensor components 218 provide sensor functionality, and may correspond to sensors built into user device 102 or sensor peripherals coupled to user device 102. Sensor components 218 may include any sensory device that captures information related to user 110 and/or user device 102 (or friend 138 and/or friend device 136) that may be associated with any actions that user 110 performs using user device 102 or friend 138 performs using friend device 136. Sensor components 218 may include camera and imaging components, accelerometers, biometric readers, GPS devices, motion capture devices, and other devices that are capable of providing information about user device 102 or user 110, or an environment therearound. Computing system 200 may also include one or more wireless transceivers 220 that may each include an antenna that is separable or integral and is capable of transmitting and receiving information according to one or more wireless network protocols, such as Wi-Fi™, 3G, 4G, HSDPA, LTE, RF, NFC, IEEE 802.11a, b, g, n, ac, or ad, Bluetooth®, Bluetooth® Low Energy (BLE), WiMAX, ZigBee®, high-frequency sound, etc. In some embodiments, wireless transceivers 220 may also be used along with location component 216 to determine a location of computing system 200. Moreover, wireless transceivers 220 may be used to send and receive additional information, send check-in and/or payment information. For example, wireless components may be a BLE component configured to communicate with one or more BLE Beacons installed at a location of a merchant to check in to the location, process payments for items purchased at the location and, in some embodiments, add an expiring balance to an account associated with a checked-in user. Checking in and processing payments using BLE Beacons is further described in U.S. patent application Ser. No. 13/938,860, filed on Jul. 10, 2013, and U.S. patent application Ser. No. 14/021,045, filed on Sep. 9, 2013, the entire contents of both of these applications which are hereby incorporated by reference in their entirety.

Computing system 200 may perform specific operations by processing component 206 executing one or more sequences of instructions contained in memory component 208. In other embodiments, hard-wired circuitry may be used in place of or in combination with software instructions to implement the present disclosure. Logic may be encoded in a computer readable medium, which may refer to any medium that participates in providing instructions to processing component 206 for execution, including memory component 208. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 222 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 222 and network interface component 202 and wireless transceiver 220. Received program code may be executed by processing component 206 as received and/or stored in memory component 208.

Computing system 200 may include more or less components than shown in FIG. 2 according to some embodiments. Moreover, components shown in FIG. 2 may be directly coupled to one or more other components in FIG. 2, eliminating a need for system bus 204. Furthermore, components shown in FIG. 2 may be shown as being part of a unitary system 200, but may also be part of a system where the components are separate but coupled and in communication. In general, the components shown in FIG. 2 are shown as examples of components in a computing system 200 capable of performing embodiments disclosed herein. However, a processing system 200 may have more or fewer components and still be capable of performing some embodiments disclosed herein.

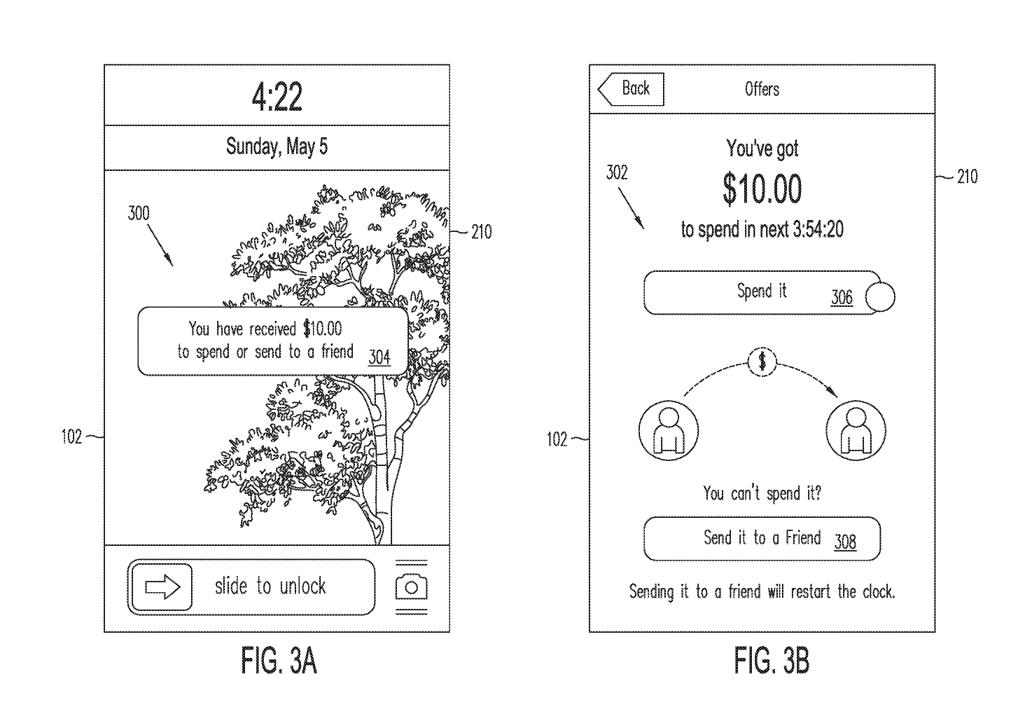

FIGS. 3A and 3B are example interfaces 300 and 302 for spending or passing along an expiring balance, consistent with some embodiments. In some embodiments, interfaces 300 and 302 may be interfaces displayed as part of payment application 114. As shown in FIG. 3A, when payment processor server 106 deposits an expiring balance in an account associated with user 110, payment processor server 106 may send a notification 304 to user device 102, wherein interface 300 including notification 304 may be displayed by display component 210 of user device 102. In some embodiments, the expiring balance may be deposited in an account associated with user 110 based on a promotion, or as a reward for frequenting a location, and the like. In some embodiments, the expiring balance may be deposited in an account associated with user 110 based on a location of user 110. For example, payment application 114 may be configured to obtain a location from location component 216 and provide the location to payment processor server 106. Payment processor server 106 may then add the expiring balance to an account associated with user 110 when the received location matches a location participating a promotion or program that uses an expiring balance. Alternatively, the location of user 110 may be determined by a geofence, such that when user 110 enters the geofenced area, a notification is provided to payment processing server 106, and the expiring balance is added to an account associated with user 110. As another example, payment application 114 may be configured to check in to a location and when payment processor server 106 processes the check in at the location, payment processor server 106 may add an expiring balance associated with user 110 when the location at which user 110 is checking in at matches a location participating in an expiring balance program. The check in may be made through payment application 114 and may be made by communicating with a BLE beacon, such as described in U.S. patent application Ser. No. 13/938,860, filed on Jul. 10, 2013, and U.S. patent application Ser. No. 14/021,045, filed on Sep. 9, 2013. User 110 may then be able to select or otherwise interact with notification 304 using input component 212, navigation control 214, or a combination thereof.

When user 110 interacts or otherwise selects notification 304, payment application 114 may be executed and user 110 may be presented with interface 302, as shown in FIG. 3B. Interface 302 may provide information to user 110, such as the amount of the expiring balance, as well as an expiration time in which to spend the balance. Interface 302 may further include options for spending the expiring balance 306, or sending the expiring balance on to a friend 308. In some embodiments, if user 110 selects option 306 to spend the expiring balance, payment application 114 may cause another interface may be displayed by display component 210 for identifying merchants at which to spend the balance. Similarly, if user selects option 308 to send the expiring balance to a friend 138, payment application 114 may cause another interface for selecting a friend to send the balance to may be displayed by display component 210.

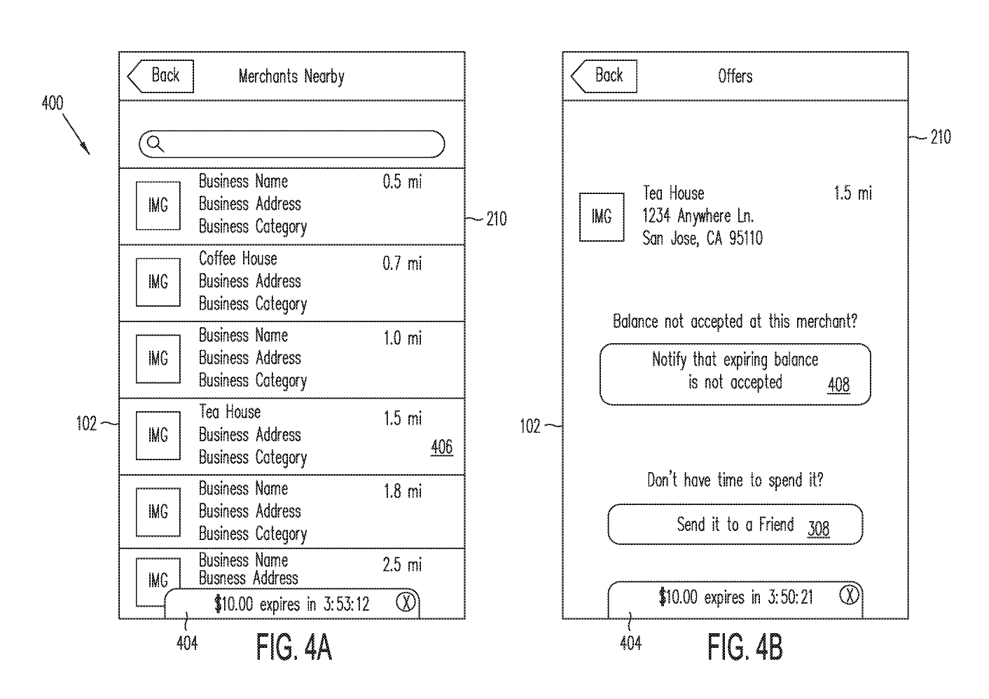

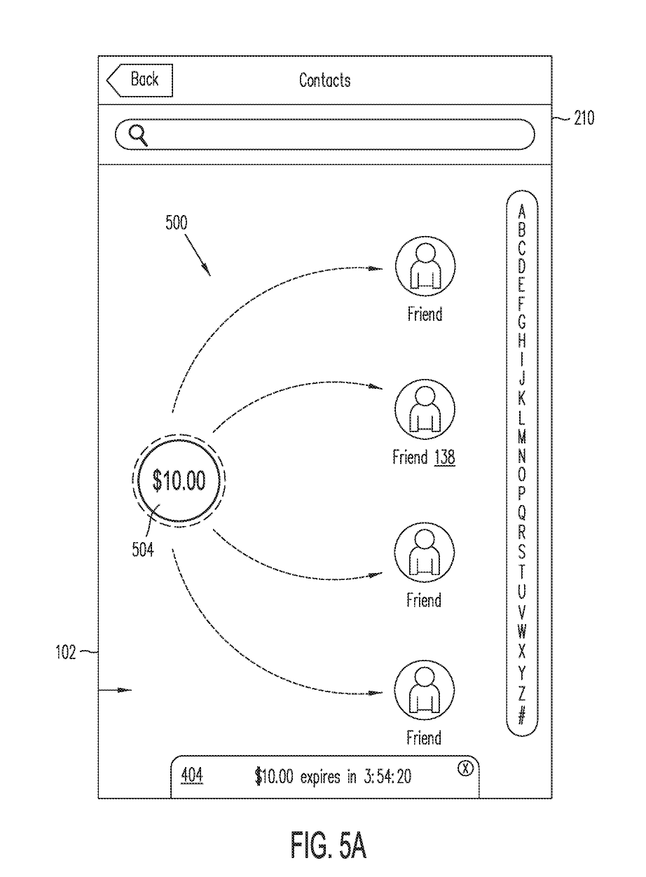

FIGS. 4A and 4B are example interfaces for identifying nearby merchants 400 and notifying 402 payment processor server 106 that an expiring balance is not accepted, consistent with some embodiments. In some embodiments, interfaces 400 and 402 may be interfaces displayed as part of payment application 114. As shown in FIG. 4A, when user 110 selects option 306 to spend the expiring balance, payment application 114 may cause interface 400 listing nearby merchants to be displayed by display component 210 of user device 102. In some embodiments, the list of nearby merchants may be sent by payment processor server 106 in response to a request for nearby merchants, the request including a geographical location provided by location component 216 for filtering the locations according to the geographical location. In some embodiments, payment application 114 or 142 may include a list or database of merchants and may filter the list based on a geographical location provided by location component 216. In other embodiments, a list of merchants may be received by user device 102 from payment processor server 106, and the list may be filtered based on a geographical location provided by location component 216. In embodiments in which the expiring balance is added into an account associated with user 110 based on a location of user 110, the list of merchants may only include merchants near a location of user 110. In embodiments where the expiring balance is added into an account associated with user 110 based on a user 110 check in at a location, instead of a listing of nearby merchants, user device 102 may present user 110 with a listing of items user 110 can purchase and/or order with the expiring balance, such that user 110 can order and pay for the item from the interface.

Interface 400 may include a notification 404 that provides user 110 with the amount of the expiring balance as well as the time remaining until the balance expires. Although notification 404 is shown as being displayed on a bottom portion of interface 400, in some embodiments, notification 404 may be shown on any part of interface 400. Using interface 400, user 110 may select one or more of the merchant entries, such as entry 406, which may bring up additional options for user 110, such as ordering items, checking in, authorizing payments, and the like.

When user 110 encounters a merchant that does not accept the expiring balance, user 110 may use payment application 114 to bring up interface 402 for notifying payment processor server 104 that the balance is not accepted, as shown in FIG. 4B. In some embodiments, when user 110 encounters a merchant that does not accept the expiring balance, user 110 may be able to select a merchant entry from interface 400 (cf. FIG. 4A), such as entry 406, and payment application 114 may cause interface 402 to be presented. As shown in FIG. 4B, if the merchant does not accept the expiring balance, user 110 may be able to select button 408 to notify payment processor server 106 that the merchant does not accept the expiring balance. Interface 402 may further include option 308 for sending or passing along the expiring balance to friend 138 as well as notification 404.

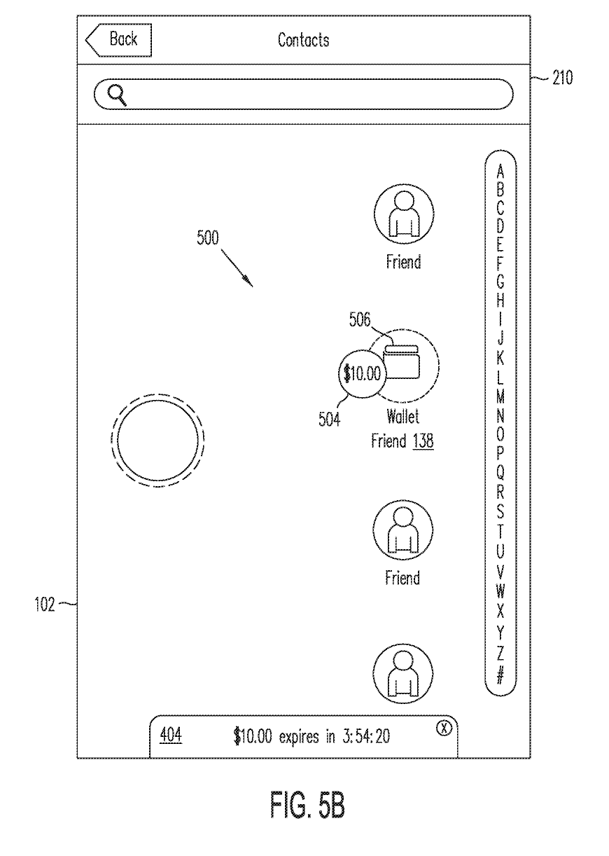

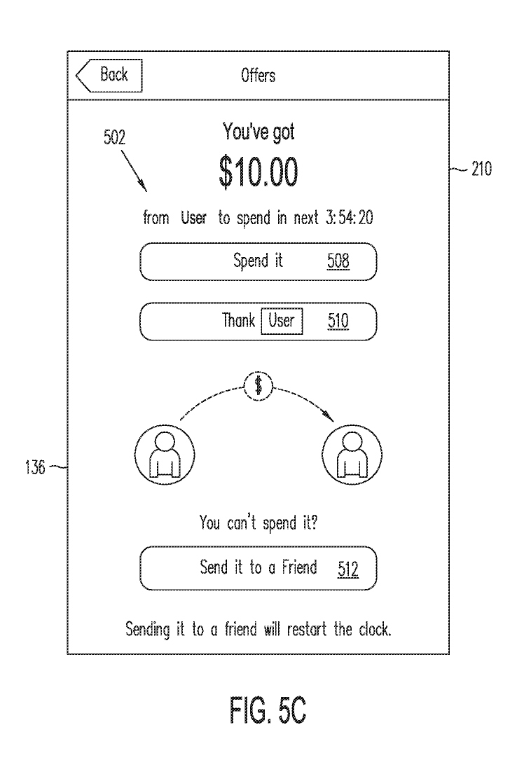

FIGS. 5A-5C are example interfaces 500 and 502 for selecting a friend to pass the expiring balance along to and receiving the expiring balance that was passed along, according to some embodiments. In some embodiments, interfaces 500 and 502 may be interfaces displayed as part of payment application 114 or 142. If user selects option 308 in interface 302 or 402, payment application 114 may cause interface 500 shown in FIG. 5A to be displayed by display component 210 of user device 102. Interface 500 may include a listing of contacts related to user 110. In some embodiments, the listing of contacts may be retrieved from memory component 208 of user device 102, or may be stored in account information 130 of payment processor server 106 and provided to payment application 114. Moreover, the listing of contacts may be filtered based on a location of user 110 and/or a location, current or listed, of the contact. Interface 500 may allow user 110 to select expiring balance 504 and move, slide, or swipe expiring balance 504 to a contact or friend from the contact list. For example, as shown in FIG. 5B, user 110 may be able to move expiring balance 504 to an electronic wallet 506 associated with friend 138.

As shown in FIG. 5C, payment application 142 may cause interface 502 to be displayed by display component 210 of friend device 136 when expiring balance 504 is sent or passed along to friend 138. In some embodiments, friend 138 may first be presented with interface 300 shown in FIG. 3A along with notification 304 that a balance has been passed along to friend 138. When friend 138 interacts or otherwise selects notification 304, payment application 142 may be executed and friend 138 may be presented with interface 502. In some embodiments, if friend 138 does not have payment application 142 installed on user device 102, selecting notification 304 may allow friend 138 to download and/or install payment application 142. In some embodiments, notification 304 may instead be an e-mail or short messaging service (SMS) message may be sent to friend 138 and friend device 136 that includes information about the expiring balance as well as a link to download and/or install payment application 142.

Interface 502 may further include an option 508 for spending the received expiring balance. In some embodiments, selecting option 508 may cause payment application 142 to display an interface similar to interface 400 shown in FIG. 4. Interface 502 may also include an option 510 for thanking user 110 for providing the expiring balance. In some embodiments, selecting option 510 may cause payment application 142 to send a thank you message to user 110. In some embodiments, the thank you message may be a push notification sent through payment application 114, an e-mail, a short messaging service (SMS) message, and the like. Interface 502 may further include an option 512 for friend 138 to pass along the expiring balance to another friend. In some embodiments, selecting option 512 may cause payment application 142 to display interface 500, where friend 138 can now select and move expiring balance 504 to a contact.

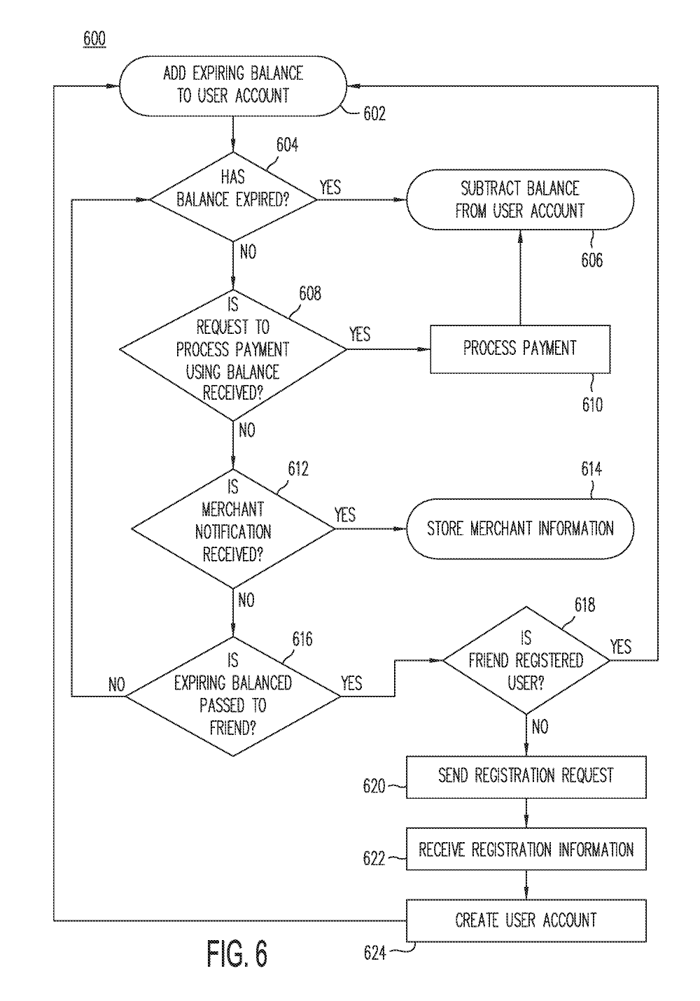

FIG. 6 is a flowchart illustrating a process 600 for providing an expiring balance to a user for spending or passing along to a friend, consistent with some embodiments. For the purpose of illustration, FIG. 6 will be described with reference to any of FIGS. 1, 2, 3A-3B, 4A-4B, or 5A-5C. Process 600 shown in FIG. 6 may be embodied in computer-readable instructions for execution by one or more processors in processing component 206 such that the steps of process 600 may be performed by payment processor server 106. As shown in FIG. 6, process 600 may begin when payment processor server 106 adds an expiring balance to an account of user 110 (602). In some embodiments, the expiring balance may have a predetermined time associated with it, after which, the balance expires and is not available to user 110. The account of user 110 may be included in account information 130 of account database 128. In some embodiments, the expiring balance may be deposited in an account associated with user 110 based on a location of user 110. For example, payment application 114 may be configured to obtain a location from location component 216 and provide the location to payment processor server 106. Payment processor server 106 may then add the expiring balance to an account associated with user 110 when the received location matches a location participating a promotion or program that uses an expiring balance. Alternatively, the location of user 110 may be determined by a geofence, such that when user 110 enters the geofenced area, a notification is provided to payment processing server 106, and the expiring balance is added to an account associated with user 110. As another example, payment application 114 may be configured to check in to a location and when payment processor server 106 processes the check in at the location, payment processor server 106 may add an expiring balance associated with user 110 when the location at which user 110 is checking in at matches a location participating in an expiring balance program. The check in may be made through payment application 114 and may be made by communicating with a BLE beacon, such as described in U.S. patent application Ser. No. 13/938,860, filed on Jul. 10, 2013, and U.S. patent application Ser. No. 14/021,045, filed on Sep. 9, 2013.

Processing component 206 of payment processor server 106 may determine when the balance expires (604) and subtract the balance from the account of user 110 when the balance expires (606). In some embodiments, the determination of when the balance expires may be made continuously. Processing component 206 of payment processor server 106 may also determine when a request to process a payment using the expiring balance is received (608) and process the payment (610) and subtract the balance from an account of user 110 (606) when it is determined that a request to process a payment using the expiring balance is received. In some embodiments, the request to process a payment may be received from user device 102 or merchant server 104. In some embodiments, user 110 using payment application 114 of user device 102 may be able to request to process a payment by checking in to a location related to merchant server 104 or authorizing that a merchant receive a payment for an amount that may include the expiring balance.

Processing component 206 of payment processor server 106 may further determine when a merchant notification is received (612) and store the merchant information in a memory component 208 and/or databases 128 or 134 (614). In some embodiments, user 110 using payment application 114 of user device 102 may be able to provide information about a merchant that does not accept the expiring balance, which may include merchants that do not accept any payment processed by payment processor server 106. The provided information may include a merchant name, location, and the like. In some embodiments, user 102 may only need to provide the merchant name, and the location may be automatically determined by payment application 114 using data provided by location component 216 of user device 102. In some embodiments, the merchant information may be provided to a sales organization that may perform outreach to merchants that do not accept the expiring balance on behalf of payment processor server 106.

Processing component 206 of payment processor server 106 may also determine when user 110 passes the expiring balance to friend 138 (616). In some embodiments, user 110 may not be able to spend the balance within the expiration time or may not want to spend it or otherwise want to provide the balance to friend 138. When payment processor server 106 receives a request to pass the balance along to friend 138, processing component 206 may determine whether friend 138 is a registered user of the payment processing service provided by payment processor server 106 (618). When friend 138 is a registered user, the expiring balance may be added to the account of friend 138 (602), and process 600 may proceed as before. When friend 138 is determined to not be a registered user, processing component 206 of payment processor server 106 may cause a registration request to be sent to friend 138 (620). The registration request may include a link to download and install payment application 142 associated with payment processor server 106. When payment processor server 106 receives registration information in response to the registration request (622) an account may be created for friend 138 (624) and the expiring balance may be added to the account of friend 138 (602) such that process 600 may proceed as before.

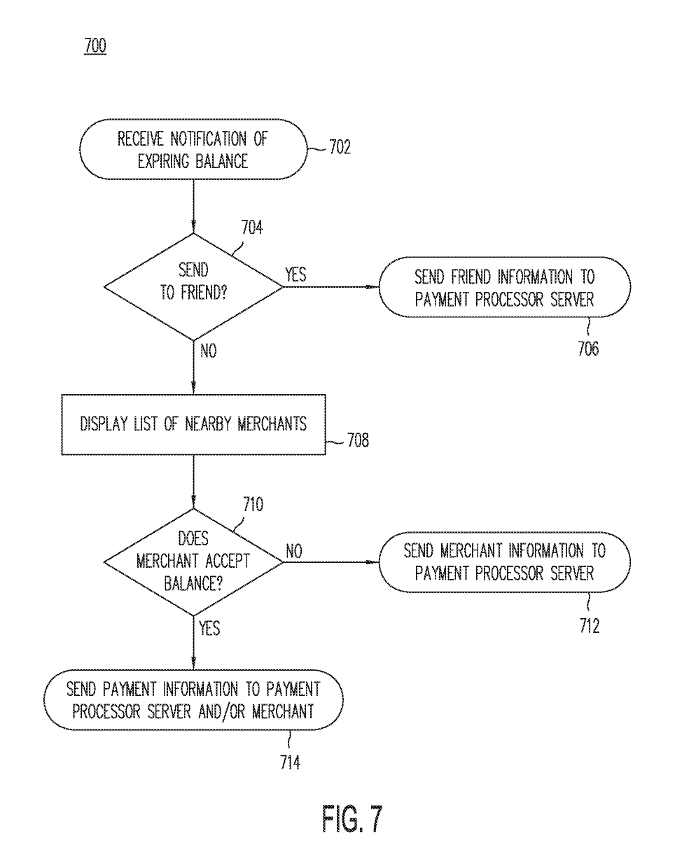

FIG. 7 is a flowchart illustrating a process 700 for spending or passing along an expiring balance, consistent with some embodiments. For the purpose of illustration, FIG. 7 will be described with reference to any of FIGS. 1, 2, 3A-3B, 4A-4B, or 5A-5C. Process 700 shown in FIG. 7 may be embodied in computer-readable instructions for execution by one or more processors in processing component 206 such that the steps of process 700 may be performed by payment processor server 106. As shown in FIG. 7, process 700 may begin when user device 102 receives a notification of an expiring balance (702). In some embodiments, payment processor server 106 may send the notification to user device 102 when payment processor server 106 adds the expiring balance to an account of user 110 in account database 128. In some embodiments, the received expiring balance may generate a push notification that may be displayed by display component 210 of user device 102. In some embodiments, selecting or otherwise activating the push notification may activate payment application 114 which may display the amount of the expiring balance as well as the time remaining until the balance expires. In some embodiments, the received expiring balance may be deposited in an account associated with user 110 based on a location of user 110, such as a geofence or a location-based check in. Payment application 114 may further display options for passing the balance to friend 138 or spending the balance which, when selected, may bring up a display of nearby merchants.

If user 110 wants to send the balance to friend 138 (704), user 110 may be required to enter information about the friend, such as an e-mail address or phone number, which will be sent to payment processor server 106 (706). In some embodiments, selecting an option to send the balance to friend 138 may bring up a list of contacts, which may be filtered based on a location of user 110 and/or friend 138, from which user 110 may select the contact to send the balance to or drag or swipe a graphical representation of the expiring balance to a contact. If user 110 wants to spend the expiring balance, a list of nearby merchants may be displayed (708). User 110 may then attempt to spend the expiring balance at the merchant, and when the merchant accepts the expiring balance (710), payment application 114 may send the payment information to payment processor server 106 or to merchant or merchant server 104 for sending to payment processor server 106 (712). However, when the merchant does not accept the balance (710), user 110 may be able to provide information about the merchant to payment processor server 106 (712). In some embodiments, user 110 may be able to access a list of merchants that are known to accept the expiring balance. The list may be received from payment processor server 106 and, in some embodiments, may only be provided after reporting at least one merchant that does not accept an expiring balance. The provided information may include a merchant name, location, and the like. In some embodiments, user 102 may only need to provide the merchant name, and the location may be automatically determined by payment application 114 using data provided by location component 216 of user device 102. Consequently, an administrator of payment processor server 106 may be able to retrieve the provided merchant information and potentially contact the merchant to attempt to register merchant with the payment processing service provided by payment processor server 106.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may provide systems and methods for providing an expiring balance for spending or sharing. In particular, the embodiments provided herein may provide incentives and motivation for additional users to register with an online payment processor and for additional merchants to register with the payment processor to take advantage of the additional business that may be generated by users spending the expiring balance. The examples provided above are exemplary only and are not intended to be limiting. One skilled in the art may readily devise other systems consistent with the disclosed embodiments which are intended to be within the scope of this disclosure. As such, the application is limited only by the following claims.

1. A system comprising:
a non-transitory memory; and
one or more hardware processors coupled to the non-transitory memory and configured to read instructions from the non-transitory memory to cause the system to perform operations comprising:
detecting an entrance into a geo-fenced area comprising a plurality of merchants;
in response to the detecting, receiving a notification of an expiring balance;
populating an application interface of a mobile application executing on the system with an amount of the expiring balance, a time left to use the expiring balance, and an option to send the expiring balance to one or more friends;
in response to selecting the option, displaying friend information for a set of the one or more friend within the geo-fenced area and an interface for selecting one of the set of friends, wherein the friend information comprises contact data for the set of friends within a contact list application of the system;
sending, to a service provider associated with the expiring balance, the friend information when the expiring balance is sent to the selected one friend; and
displaying a notification from the one friend.

2. The system of claim 1, wherein receiving the notification of the received expiring balance comprises receiving at least one of a short messaging service (SMS) message, an e-mail, or a push notification.

3. The system of claim 1, wherein sending the friend information comprises sending at least one of a phone number of the one friend or an e-mail address of the one friend.

4. The system of claim 1, wherein the one friend is selected from the one or more friends from the contact list application.

5.-7. (canceled)

8. The system of claim 1, wherein receiving the notification of the expiring balance comprises:
providing a location to the service provider; and
receiving the notification of the expiring balance based on the location being within the geo-fenced area.

9. The system of claim 8, wherein providing the location comprises at least one of providing the location using a location detection component, entering the geo-fenced area, or checking into the location.

10. The system of claim 9, wherein checking into the location comprises checking into the location using a Bluetooth® low energy (BLE) communications protocol with a wireless beacon associated with the geo-fenced area.

11. The system of claim 1, wherein the service provider transmits a communication comprising a registration request for an account to the one friend using the contact data, and wherein the registration request comprises a link to establish the account for the one friend.

12. The system of claim 1, wherein the sending the friend information comprises sending a credential associated with an account having the expiring balance for retrieval of a balance identifier for the expiring balance.

13. A method comprising:
detecting an entrance into a geo-fenced area comprising a plurality of merchants;
in response to the detecting, receiving a notification through a mobile application of a first mobile computing device of an expiring balance;
populating an application interface of the mobile application with an amount of the expiring balance, a time left to use the expiring balance, and an option to send the expiring balance to one or more friends;
displaying a list of the plurality of merchants within the application interface;
in response to receiving a selection of one of the plurality of merchants, communicating with a merchant device of the one of the plurality of merchants to determine whether the one of the plurality of merchants accepts the expiring balance; and
sending, to a service provider, merchant information for the one of the plurality of merchants when the one of the plurality of merchants does not accept the expiring balance.

14. The method of claim 13, wherein displaying the list of the plurality of merchants comprises:
receiving a request to view available balances including the expiring balance; and
sending current GPS coordinates to a server.

15. The method of claim 13, wherein the list comprises at least one merchant that has accepted a previous expiring balance of a same type as the expiring balance.

16. The method of claim 13, wherein receiving the notification of the expiring balance comprises:
providing a location; and
receiving the notification of the expiring balance based on the location.

17. The method claim 16, wherein providing the location comprises at least one of providing the location using a location detection component, entering a geo-fenced area, or checking into the location.

18. The method of claim 17, wherein checking into the location comprises checking into the location using a Bluetooth® low energy (BLE) communications protocol with a wireless beacon associated with the geo-fenced area.

19. A non-transitory machine-readable medium having stored thereon machine-readable instructions executable to cause a machine to perform operations comprising:
transmitting location data for a geo-fenced area comprising a plurality of merchants to a service provider;
receiving application data for display of an expiring balance in a mobile application of the machine;
displaying the expiring balance in an application interface of the mobile application with an amount of the expiring balance and a time left to use the expiring balance;
displaying a list of the plurality of merchants within the geo-fence in the application interface with the expiring balance;
in response to receiving a selection of one of the plurality of merchants, communicating with a merchant device of the one of the plurality of merchants to determine whether the one of the plurality of merchants accepts the expiring balance; and
sending, to a service provider, merchant information for the one of the plurality of merchants when the one of the plurality of merchants does not accept the expiring balance.

20. The non-transitory machine-readable medium of claim 19, wherein the list comprises at least one merchant that has accepted a previous expiring balance of a same type as the expiring balance.

21. The non-transitory machine-readable medium of claim 19, wherein the transmitting the location data uses one of a location detection component or a check-in at the geo-fenced area.

22. The non-transitory machine-readable medium of claim 21, wherein checking into the location comprises checking into the location using a Bluetooth® low energy (BLE) communications protocol with a wireless beacon associated with the geo-fenced area.

23. The non-transitory machine-readable medium of claim 19, wherein the sending the merchant information comprises one of sending a merchant identifier or sending a merchant name.
